(19) United States
(12) Patent Application Publication
(10) Pub. No.: US 2025/0029567 A1
(43) Pub. Date: Jan. 23, 2025

(54) DISPLAY APPARATUS AND DRIVING METHOD THEREOF

(71) Applicant: LG Display Co., Ltd., Seoul (KR)

(72) Inventors: Jin Woo LEE, Paju-si (KR); Sung Wook CHOI, Paju-si (KR)

(73) Assignee: LG Display Co., Ltd., Seoul (KR)

(21) Appl. No.: 18/777,200

(22) Filed: Jul. 18, 2024

(30) Foreign Application Priority Data
Jul. 19, 2023 (KR) 10-2023-0093628

(51) Int. Cl. G09G 3/3291

(52) U.S. Cl. CPC G09G 3/3291

(57) ABSTRACT

A display apparatus in one example includes a display panel having a subpixel configured to emit light with a data voltage applied through a first data line and change an emission condition, based on an additional voltage applied through a first additional line. The display apparatus further includes a driver configured to drive the display panel.

### CROSS-REFERENCE TO RELATED APPLICATIONS

This application claims priority to Korean Patent Application No. 10-2023-0093628 filed in the Republic of Korea on Jul. 19, 2023, the entire contents of which is hereby expressly incorporated by reference into the present application.

### BACKGROUND

### Field

The present disclosure relates to a display apparatus and a driving method thereof.

### Discussion of the Related Art

As information technology advances, the market for display apparatuses which are connection mediums for connecting a user with information is growing. Therefore, the use of display apparatuses such as light emitting display apparatuses, quantum dot display (QDD) apparatuses, and liquid crystal display (LCD) apparatuses is increasing.

The display apparatuses described above include a display panel having a plurality of subpixels, a driver which outputs a driving signal for driving the display panel, and a power supply which generates power to be supplied to the display panel or the driver.

In such display apparatuses, when the driving signal (for example, a scan signal and a data signal) is supplied to each of the subpixels provided in the display panel, a selected subpixel can transmit light or can self-emit light and thus, an image can be displayed.

### SUMMARY OF THE DISCLOSURE

The present disclosure can provide a display apparatus and a driving method thereof, which can increase a moving picture response time and can also enhance an image expression performance of a display panel.

Further, the present disclosure can enhance display quality and can vary image expression, based on the use environment or use purpose of a display apparatus.

In addition, the present disclosure provides an improved display apparatus and its driving method, which can address limitations associated with the related art.

To achieve these objects and other advantages and in accordance with the purpose of the disclosure, as embodied and broadly described herein, a display apparatus includes a display panel having a subpixel configured to emit light with a data voltage applied through a first data line and change an emission condition, based on an additional voltage applied through a first additional line, and a driver configured to drive the display panel.

In one or more aspects of the present disclosure, the additional voltage can include a black data voltage consisting of a direct current (DC) voltage of 0 V.

In one or more aspects of the present disclosure, the display panel can change the emission condition to black, based on the black data voltage.

In one or more aspects of the present disclosure, the display panel can include a first data write period for applying the data voltage, an emission period for emitting light with the data voltage, and a second data write period for applying the additional voltage, and each of the first data write period, the emission period, and the second data write period can be included in one frame driving period of the display panel.

In one or more aspects of the present disclosure, the first data write period can be provided to be adjacent to a start time of the one frame driving period, and the second data write period can be provided to be adjacent to an end time of the one frame driving period.

In one or more aspects of the present disclosure, the subpixel can include a capacitor configured to store the data voltage or the additional voltage; a first switching transistor including a first electrode connected to the first data line, a second electrode connected to a gate electrode of the driving transistor and a first electrode of the capacitor, and a gate electrode connected to a first-first gate line (e.g., 1A^{th} gate line); a second switching transistor including a first electrode connected to the first additional line, a second electrode connected to the gate electrode of the driving transistor and the first electrode of the capacitor, and a gate electrode connected to a first-second gate line (e.g., 1B^{th} gate line); a driving transistor configured to operate based on the data voltage or the additional voltage stored in the capacitor; and an organic light emitting diode configured to operate based on a current generated from the driving transistor.

In one or more aspects of the present disclosure, the organic light emitting diode can include an anode electrode connected to a high-level voltage line and a cathode electrode connected to a first electrode of the driving transistor.

In one or more aspects of the present disclosure, the display panel can include a pixel including subpixels emitting different lights, and the subpixels can share the first additional line.

In another aspect of the present disclosure, a driving method of a display apparatus includes a first data write step/operation of applying a data voltage to a subpixel of a display panel through a first data line; an emission step/operation of allowing the subpixel to emit light, based on the data voltage; and a second data write step/operation of applying an additional voltage to the subpixel of the display panel through a first additional line and changing an emission condition of the subpixel, based on the additional voltage.

In one or more aspects of the present disclosure, the additional voltage can include a black data voltage consisting of a direct current (DC) voltage of 0 V.

In one or more aspects of the present disclosure, the display panel can change the emission condition to black, based on the black data voltage.

In one or more aspects of the present disclosure, each of the first data write period, the emission period, and the second data write period can be included in one frame driving period of the display panel, the first data write period can be provided to be adjacent to a start time of the one frame driving period, and the second data write period can be provided to be adjacent to an end time of the one frame driving period.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram schematically illustrating a light emitting display apparatus, and

FIGS. 2 and 3 are diagrams for describing a configuration of a scan driver of a gate in panel (GIP) type;

FIG. 4 is a circuit diagram of a subpixel according to a first embodiment of the present disclosure, and

FIGS. 5 and 6 are diagrams for divisionally describing partial operations of an operation of the subpixel according to the first embodiment of the present disclosure;

FIG. 7 is a circuit diagram of a subpixel according to a second embodiment of the present disclosure, and

FIGS. 8 and 9 are diagrams for divisionally describing partial operations of an operation of the subpixel according to the second embodiment of the present disclosure;

FIGS. 10 and 11 are configuration diagrams of a pixel capable of being implemented based on the first embodiment or the second embodiment, according to a third embodiment of the present disclosure, and

FIG. 12 is a configuration diagram of a pixel capable of being implemented according to the third embodiment of the present disclosure;

FIG. 13 is a circuit diagram of a subpixel according to a fourth embodiment of the present disclosure,

FIG. 14 is a configuration diagram of a pixel capable of being implemented based on the fourth embodiment of the present disclosure, and

FIG. 15 is a driving waveform diagram of a display panel implemented based on a subpixel according to the fourth embodiment of the present disclosure; and

FIG. 16 is a driving waveform diagram showing FIG. 15 in more detail,

FIGS. 17 to 19 are diagrams showing an operating state of a subpixel based on the driving waveform of FIG. 16, and

FIG. 20 is a configuration diagram of a data driver for driving of a display panel implemented based on a subpixel according to the fourth embodiment of the present disclosure.

### DETAILED DESCRIPTION OF THE DISCLOSURE

Hereinafter, the present disclosure will be described more fully with reference to the accompanying drawings, in which example embodiments of the disclosure are shown. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art.

Features of various embodiments of the present disclosure can be partially or entirely coupled to or combined with each other and can be operated, linked, or driven together in various ways. Embodiments of the present disclosure can be carried out independently from each other, or can be carried out together in co-dependent or related relationship. Further, the term “can” encompasses all the meanings and coverages of the term “may.”

It will be understood that, although the terms “first,” “second,” or the like can be used herein to describe various elements, these elements should not be limited by these terms, for example, to any particular order, sequence, precedence, or number of elements. These terms are only used to distinguish one element from another.

All the components of each display device or apparatus according to all embodiments of the present disclosure are operatively coupled and configured.

A display apparatus according to the present disclosure can be applied to televisions (TVs), video players, personal computers (PCs), home theaters, electronic devices for vehicles, and smartphones, but is not limited thereto. The display apparatus according to the present disclosure can be implemented as a light emitting display apparatus, a quantum dot display (QDD) apparatus, or a liquid crystal display (LCD) apparatus. Hereinafter, for convenience of description, a light emitting display apparatus self-emitting light by using an inorganic light emitting diode or an organic light emitting diode will be described for example.

Moreover, a thin film transistor (TFT) described below can be implemented with an n-type TFT, a p-type TFT, or a combination of an n-type TFT and a p-type TFT. A TFT can be a three-electrode element including a gate, a source, and a drain. The source can be an electrode which provides a carrier to a transistor. In the TFT, a carrier can start to flow from the source. The drain can be an electrode where the carrier flows from the TFT to the outside. For example, in the TFT, the carrier flows from the source to the drain.

In the p-type TFT, because a carrier is a hole, a source voltage can be higher than a drain voltage so that the hole flows from the source to the drain. In the p-type TFT, because the hole flows from the source to the drain, a current can flow from the source to the drain. On the other hand, in the n-type TFT, because a carrier is an electron, a source voltage can be lower than a drain voltage so that the electron flows from the source to the drain. In the n-type TFT, because the electron flows from the source to the drain, a current can flow from the drain to the source. However, a source and a drain of a TFT can switch therebetween based on a voltage applied thereto. Based thereon, in the following description, one of a source and a drain will be described as a first electrode, and the other of the source and the drain will be described as a second electrode.

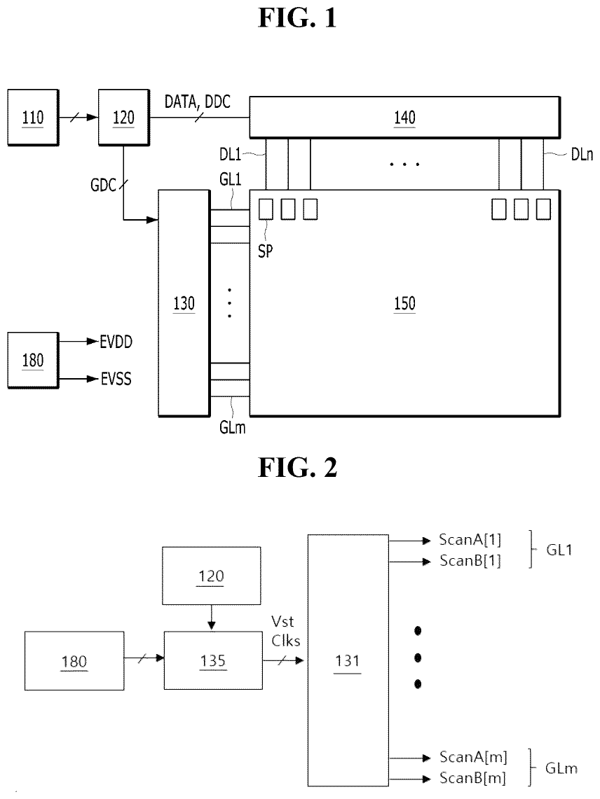

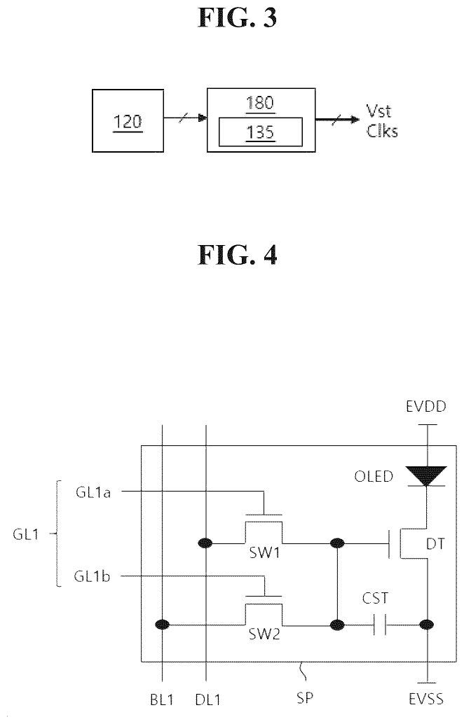

FIG. 1 is a block diagram schematically illustrating a light emitting display apparatus, and FIGS. 2 and 3 are diagrams for describing a configuration of a scan driver of a gate in panel (GIP) type.

As illustrated in FIG. 1, a light emitting display apparatus according to an embodiment of the present disclosure can include a video supply unit 110, a timing controller 120, a scan driver 130, a data driver 140, a display panel 150, and a power supply 180.

The video supply unit 110 (a set or a host system) can output a video data signal supplied from the outside or an image data signal stored in an internal memory thereof. The video supply unit 110 can supply a data signal and the various driving signals to the timing controller 120.

The timing controller 120 can output a gate timing control signal GDC for controlling an operation timing of the scan driver 130, a data timing control signal DDC for controlling an operation timing of the data driver 140, and various synchronization signals (a vertical synchronization signal Vsync and a horizontal synchronization signal Hsync). The timing controller 120 can provide the data driver 140 with the data timing control signal DDC and a data signal DATA supplied from the video supply unit 110. The timing controller 120 can be implemented as an integrated circuit (IC) type and can be mounted on a printed circuit board (PCB), but is not limited thereto.

The scan driver 130 can output a scan signal (or a scan voltage) in response to the gate timing control signal GDC supplied from the timing controller 120. The scan driver 130 can supply the scan signal to a plurality of subpixels, included in the display panel 150, through a plurality of gate lines GL1 to GLm. The scan driver 130 can be implemented as an IC type or can be directly provided on the display panel 150 in a GIP type, but is not limited thereto.

In response to the data timing control signal DDC supplied from the timing controller 120, the data driver 140 can sample and latch the data signal DATA, convert a digital data signal into an analog data voltage, based on a gamma reference voltage, and output the analog data voltage. The data driver 140 can respectively supply data voltages to the subpixels of the display panel 150 through a plurality of data lines DL1 to DLn. The data driver 140 can be implemented as an IC type or can be mounted on the display panel 150 or a PCB, but is not limited thereto.

The power supply 180 can generate a high-level voltage and a low-level voltage, based on an external input voltage supplied from the outside, and can output the high-level voltage and the low-level voltage through a high-level voltage line EVDD and a low-level voltage line EVSS. The power supply 180 can generate and output a voltage (for example, a gate high voltage and a gate low voltage) needed for driving of the scan driver 130 or a voltage (a drain voltage and a half drain voltage) needed for driving of the data driver 140, in addition to the high-level voltage and the low-level voltage.

The display panel 150 can be manufactured based on a substrate, having stiffness or flexibility, such as glass, silicon, or polyimide. The display panel 150 can include a plurality of subpixels SP for displaying an image, based on the high-level voltage, the low-level voltage, and a driving signal including a scan signal and a data voltage. The subpixel SP can be connected to a first data line DL1, a first gate line GL1, the high-level voltage line EVDD, and the low-level voltage line EVSS. The subpixel SP can each self-emit light. The subpixel SP can emit light having one color of red, green, blue, and white.

Hereinabove, each of the timing controller 120, the scan driver 130, and the data driver 140 has been described as an individual element. However, based on an implementation type of the light emitting display apparatus, one or more of the timing controller 120, the scan driver 130, and the data driver 140 can be integrated into one IC.

As illustrated in FIGS. 2 and 3, a GIP-type scan driver can include a shift register 131 and a level shifter 135. The level shifter 135 can generate scan clock signals Clks and a start signal Vst, based on signals and voltages output from the timing controller 120 and the power supply 180.

The shift register 131 can be formed as a thin film type in the display panel, based on the GIP type. The shift register 131 can operate based on the clock signals Clks and the start signal Vst output from the level shifter 135 and can output scan signals ScanA[1], ScanB[1] to ScanA[m], and ScanB[m] for turning on or off a transistor formed in the display panel. A first 1A^{th} scan signal ScanA[1] and a second 1B^{th} scan signal ScanB[1] can be applied to a first gate line GL1 (or a first scan line), and an MA^{th} scan signal ScanA[m] and an MBth scan signal ScanB[m] can be applied to an M^{th} gate line GLm (or a last scan line).

The level shifter 135 can be independently provided as an IC type unlike the shift register 131, or can be included in the power supply 180. However, this can be merely an embodiment, and embodiments of the present disclosure are not limited thereto.

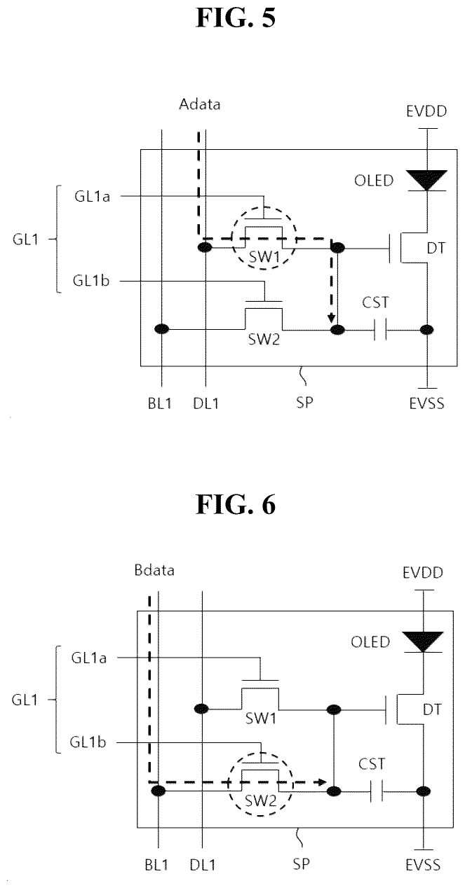

FIG. 4 is a circuit diagram of a subpixel SP according to a first embodiment of the present disclosure, and FIGS. 5 and 6 are diagrams for divisionally describing partial operations of an operation of the subpixel SP according to the first embodiment.

As illustrated in FIG. 4, the subpixel SP according to the first embodiment can include a first switching transistor SW1, a second switching transistor SW2, a capacitor CST, a driving transistor DT, and an organic light emitting diode OLED. Hereinafter, an example where the first switching transistor SW1, the second switching transistor SW2, and the driving transistor DT are selected as an n type will be described.

The first switching transistor SW1 can include a gate electrode connected to a 1A^{th} gate line GL1a (GL1a also being referred to herein as a first-first gate line), a first electrode connected to a first data line DL1, and a second electrode connected to a gate electrode of the driving transistor DT and a first electrode of the capacitor CST. The first switching transistor SW1 can transfer a data voltage, applied through the first data line DL1, to the first electrode of the capacitor CST.

The second switching transistor SW2 can include a gate electrode connected to a 1B^{th} gate line GL1b (GL1b also being referred to herein as a first-second gate line), a first electrode connected to a first additional line BL1, and a second electrode connected to the gate electrode of the driving transistor DT and the first electrode of the capacitor CST. The second switching transistor SW2 can transfer a target voltage, applied through the first additional line BL1, to the first electrode of the capacitor CST.

The capacitor CST can include the first electrode connected to the second electrode of the first switching transistor SW1, the second electrode of the second switching transistor SW2, and the gate electrode of the driving transistor DT and a second electrode connected to a second electrode of the driving transistor DT and a low-level voltage line EVSS. The capacitor CST can store the data voltage or the additional voltage.

The driving transistor DT can include the gate electrode connected to the second electrode of the first switching transistor SW1, the second electrode of the second switching transistor SW2, and the first electrode of the capacitor CST, a first electrode connected to a cathode electrode of an organic light emitting diode OLED, and the second electrode connected to the second electrode of the capacitor CST and the low-level voltage line EVSS. The driving transistor DT can operate based on the data voltage or the additional voltage stored in the capacitor CST.

The organic light emitting diode OLED can include an anode electrode connected to a high-level voltage line EVDD and the cathode electrode connected to the first electrode of the driving transistor DT. The organic light emitting diode OLED can emit light, based on an operation of the driving transistor DT.

As illustrated in FIG. 5, in the subpixel SP according to the first embodiment, the first switching transistor SW1 can be turned on for a first time and can thus transfer a data voltage Adata, applied through the first data line DL1, to the first electrode of the capacitor CST. When the data voltage Adata is transferred to the first electrode of the capacitor CST, the driving transistor DT can start an operation, based on the data voltage stored in the capacitor CST. The organic light emitting diode OLED can emit light, based on a start operation of the driving transistor DT.

As illustrated in FIG. 6, in the subpixel SP according to the first embodiment, the second switching transistor SW2 can be turned on for a second time after the first time and can thus transfer an additional voltage Bdata, applied through the first additional line BL1, to the first electrode of the capacitor CST. When the additional voltage Bdata is transferred to the first electrode of the capacitor CST, the driving transistor DT can stop the operation, based on the additional voltage stored in the capacitor CST. The organic light emitting diode OLED may not emit light or can implement black, based on a stop operation of the driving transistor DT.

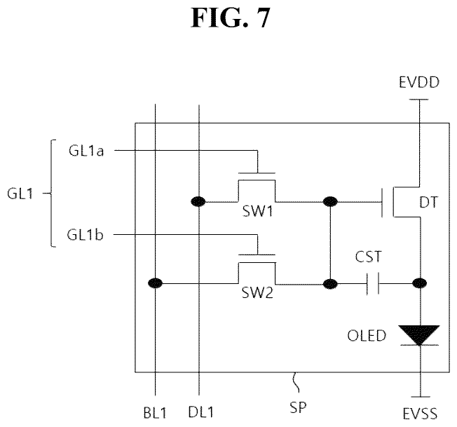

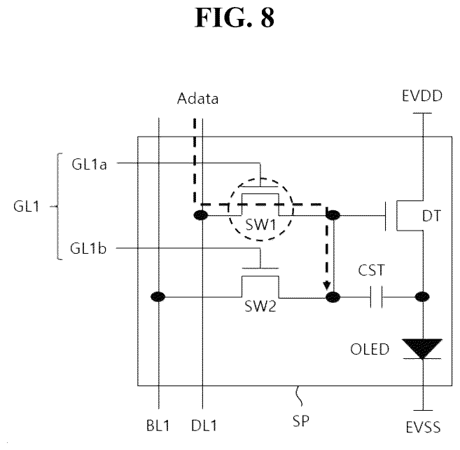

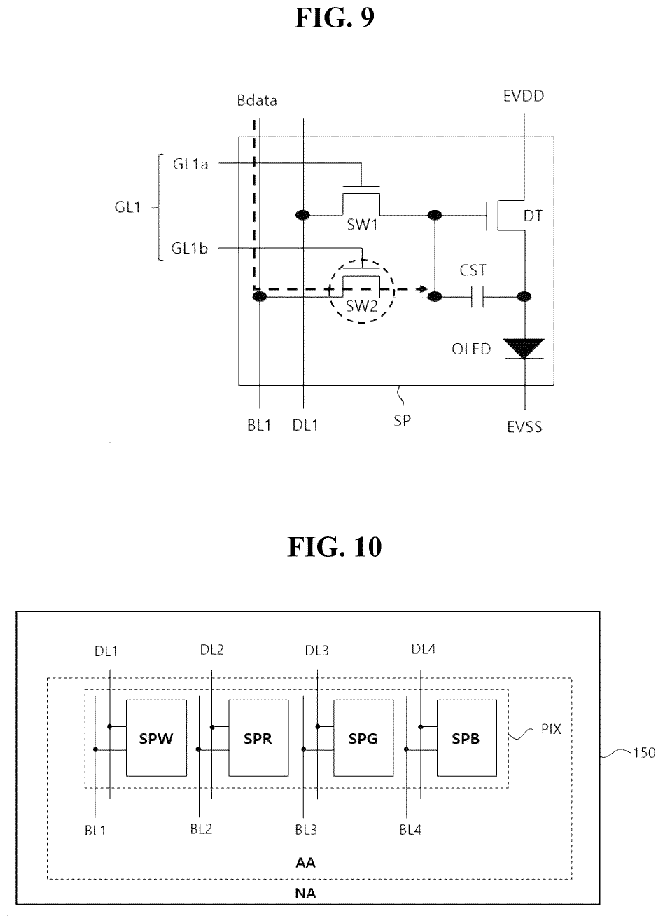

FIG. 7 is a circuit diagram of a subpixel SP according to a second embodiment of the present disclosure, and FIGS. 8 and 9 are diagrams for divisionally describing partial operations of an operation of the subpixel SP according to the second embodiment.

As illustrated in FIG. 7, the subpixel SP according to the second embodiment can include a first switching transistor SW1, a second switching transistor SW2, a capacitor CST, a driving transistor DT, and an organic light emitting diode OLED.

The first switching transistor SW1 can include a gate electrode connected to a 1A^{th} gate line GL1a, a first electrode connected to a first data line DL1, and a second electrode connected to a gate electrode of the driving transistor DT and a first electrode of the capacitor CST. The first switching transistor SW1 can transfer a data voltage, applied through the first data line DL1, to the first electrode of the capacitor CST.

The second switching transistor SW2 can include a gate electrode connected to a 1B^{th} gate line GL1b, a first electrode connected to a first additional line BL1, and a second electrode connected to the gate electrode of the driving transistor DT and the first electrode of the capacitor CST. The second switching transistor SW2 can transfer a target voltage, applied through the first additional line BL1, to the first electrode of the capacitor CST.

The capacitor CST can include the first electrode connected to the second electrode of the first switching transistor SW1, the second electrode of the second switching transistor SW2, and the gate electrode of the driving transistor DT and a second electrode connected to a second electrode of the driving transistor DT and an anode electrode of the organic light emitting diode OLED. The capacitor CST can store the data voltage or the additional voltage.

The driving transistor DT can include the gate electrode connected to the second electrode of the first switching transistor SW1, the second electrode of the second switching transistor SW2, and the first electrode of the capacitor CST, a first electrode connected to a high-level voltage line EVDD, and the second electrode connected to the second electrode of the capacitor CST and the anode electrode of the organic light emitting diode OLED. The driving transistor DT can operate based on the data voltage or the additional voltage stored in the capacitor CST.

The organic light emitting diode OLED can include the anode electrode connected to the second electrode of the driving transistor DT and the cathode electrode connected to the low-level voltage line EVSS. The organic light emitting diode OLED can emit light, based on an operation of the driving transistor DT.

As illustrated in FIGS. 8 and 9, the subpixel SP according to the second embodiment can operate as a type which is equal or similar to the subpixel SP according to the first embodiment, and thus, this can be described with reference to the first embodiment.

Furthermore, in the first embodiment and the second embodiment, an example has been described where the additional voltage for stopping an operation of the driving transistor DT so as to allow the organic light emitting diode OLED not to emit light is applied in the form of a black data voltage. However, the additional voltage can be changed to a type for changing (emission period limitation or gray level change) an emission condition and a condition which stops an emission operation of the subpixel SP. Accordingly, a level of the additional voltage applied through the first additional line BL1 can vary based on image expression using the display panel.

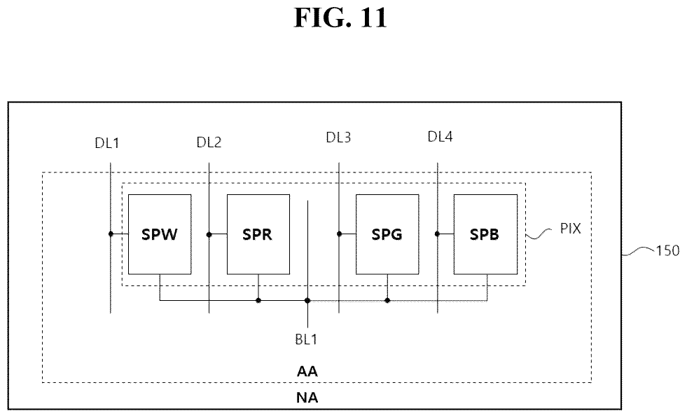

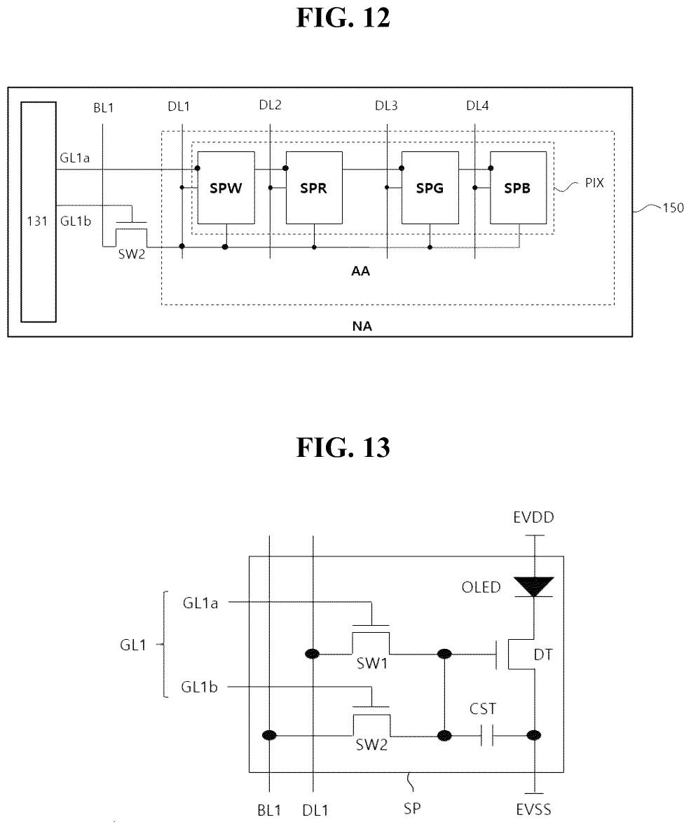

FIGS. 10 and 11 are configuration diagrams of a pixel capable of being implemented based on the first embodiment or the second embodiment, according to a third embodiment of the present disclosure, and FIG. 12 is a configuration diagram of a pixel capable of being implemented according to the third embodiment.

As illustrated in FIGS. 10 to 12, a pixel PIX according to the third embodiment can be implemented based on the subpixel according to the first embodiment or the second embodiment. Hereinafter, an example where the pixel PIX includes a white subpixel SPW, a red subpixel SPR, a green subpixel SPG, and a blue subpixel SPB arranged in a horizontal direction will be described. However, subpixels included in the pixel PIX can be arranged in a vertical direction or a diagonal direction.

As illustrated in FIG. 10, the white subpixel SPW, the red subpixel SPR, the green subpixel SPG, and the blue subpixel SPB included in the pixel PIX can be respectively connected to first to fourth data lines DL1 to DLA and can be respectively connected to first to fourth additional lines BL1 to BL4. For example, the white subpixel SPW can be connected to the first data line DL1 and the first additional line BL1, and the red subpixel SPR can be connected to the second data line DL2 and the second additional line BL2.

A structure illustrated in FIG. 10 can apply a common additional voltage to the subpixels included in the pixel PIX and can respectively apply differentiated additional voltages to the subpixels included in the pixel PIX. The structure illustrated in FIG. 10 can apply the additional voltage for each subpixel, and thus, the implementation of a specific color (a specific gray level) can be enhanced.

As illustrated in FIG. 11, the white subpixel SPW, the red subpixel SPR, the green subpixel SPG, and the blue subpixel SPB included in the pixel PIX can be respectively connected to the first to fourth data lines DL1 to DLA and can share one first additional line BL1. In a case where four subpixels are divided into two pairs, an example is illustrated where the first additional line BL1 is disposed between the red subpixel SPR and the green subpixel SPG which are a center region thereof, but embodiments of the present disclosure are not limited thereto.

A structure illustrated in FIG. 11 can apply a common additional voltage to the subpixels included in the pixel PIX. In FIG. 11, an example where four subpixels included in the pixel PIX share one first additional line BL1 is illustrated, but the pixel PIX can be implemented in a structure where one additional line is shared by two subpixels each. Comparing with the structure illustrated in FIG. 10, in the structure illustrated in FIG. 11, the number of arranged additional lines can decrease, and thus, a reduction in aperture ratio of a subpixel can decrease.

As illustrated in FIG. 12, a white subpixel SPW, a red subpixel SPR, a green subpixel SPG, and a blue subpixel SPB included in a pixel PIX can be respectively connected to first to fourth data lines DL1 to DLA and can share one first additional line BL1. According to FIG. 12, a first additional line BL1 and a second switching transistor SW2 for transferring an additional voltage can be disposed in a non-display area NA outside a display area AA instead of the inside of each subpixel.

A structure illustrated in FIG. 12 can apply a common additional voltage to the subpixels included in the pixel PIX. In FIG. 12, an example where four subpixels included in the pixel PIX share one first additional line BL1 is illustrated, but the pixel PIX can be implemented in a structure where all subpixels disposed in one scan line share one first additional line BL1. Comparing with the structure illustrated in FIG. 11, in the structure illustrated in FIG. 12, the number of additional lines and second switching transistors can decrease, and thus, a reduction in aperture ratio of a subpixel can more decrease.

Hereinafter, in a fourth embodiment of the present disclosure, an example which implements a display apparatus for increasing a motion/moving picture response time (MPRT) by using the subpixel according to the first embodiment depending on the case will be described.

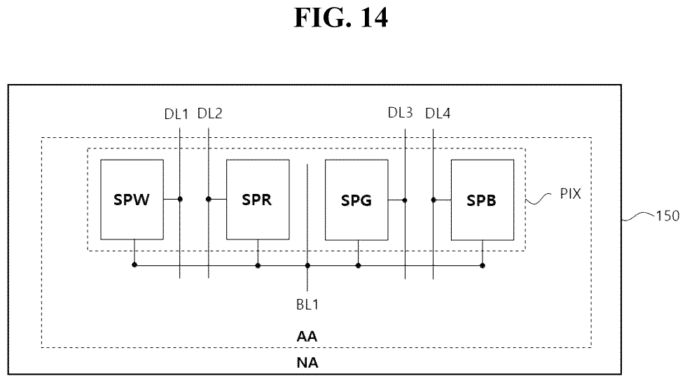

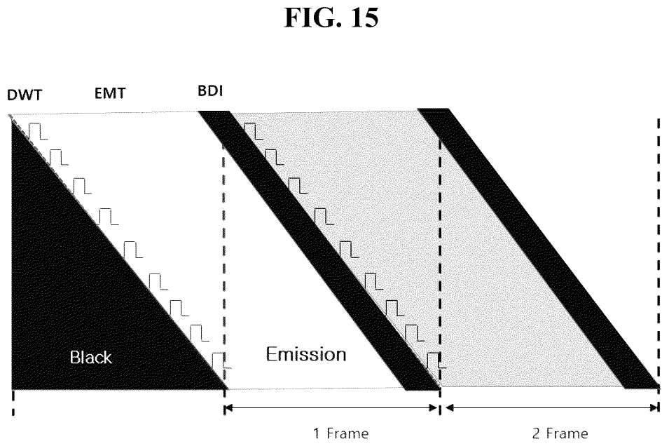

FIG. 13 is a circuit diagram of a subpixel SP according to the fourth embodiment, FIG. 14 is a configuration diagram of a pixel capable of being implemented based on the fourth embodiment, and FIG. 15 is a driving waveform diagram of a display panel implemented based on the subpixel SP according to the fourth embodiment.

As illustrated in FIG. 13, the subpixel SP according to the fourth embodiment can be the same as the configuration and connection relationship of the subpixel according to the first embodiment. Accordingly, relevant descriptions can refer to the first embodiment.

As illustrated in FIG. 14, a white subpixel SPW, a red subpixel SPR, a green subpixel SPG, and a blue subpixel SPB included in a pixel PIX can be respectively connected to first to fourth data lines DL1 to DL4 and can share one first additional line BL1.

A structure illustrated in FIG. 14 can be similar to the structure illustrated in FIG. 11, but there can be a difference therebetween in that the first data line DL1 and the second data line DL2 are disposed between the white subpixel SPW and the red subpixel SPR, and the third data line DL3 and the fourth data line DL4 are disposed between the green subpixel SPG and the blue subpixel SPB. Furthermore, in FIG. 14, in a case where four subpixels are divided into two pairs, an example is illustrated where the first additional line BL1 is disposed between the red subpixel SPR and the green subpixel SPG which are a center region thereof, but embodiments of the present disclosure are not limited thereto.

As illustrated in FIG. 15, a display panel implemented based on the subpixel according to the fourth embodiment can divisionally operate in a data write period DWT, an emission period EMT, and a black data write period BDI of one frame driving period. However, it should be understood that the black data write period BDI is not included in all frame driving periods but is included in at least one frame driving period, based on user definition or device option.

The data write period DWT can be defined as a first data write period where a data voltage is written in each of the subpixels included in the display panel. The emission period EMT can be defined as an image display period where light is emitted based on the data voltage written in each of the subpixels included in the display panel. The black data write period BDI can be defined as a second data write period where a black data voltage instead of the data voltage is written in each of the subpixels included in the display panel.

The display panel implemented based on the subpixel according to the fourth embodiment can emit light for displaying an image during the emission period EMT, and then, as being changed (shifted) to black during the black data write period BDI, the display panel may not emit light. The data write period DWT and the black data write period BDI can be sequentially performed up to a lower end of the display panel from an upper end of the display panel along gate lines (or scan lines).

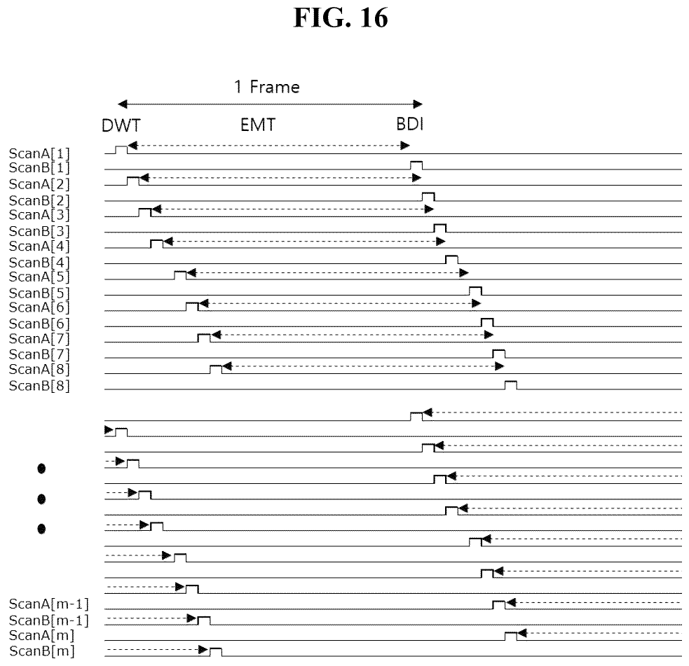

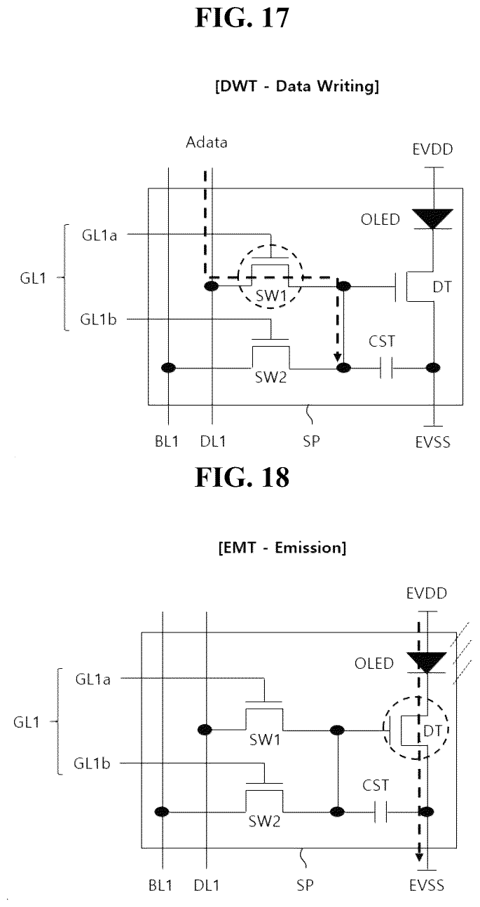

FIG. 16 is a driving waveform diagram showing FIG. 15 in more detail, FIGS. 17 to 19 are diagrams showing an operating state of a subpixel based on the driving waveform of FIG. 16, and FIG. 20 is a configuration diagram of a data driver for driving of a display panel implemented based on a subpixel according to the fourth embodiment.

As illustrated in FIG. 16, scan signals ScanA[1], ScanB[1] to ScanA[m], and ScanB[m] for defining the data write period DWT, the emission period EMT, and the black data write period BDI can be applied to the display panel.

A 1A^{th} scan signal ScanA[1] and a 1B^{th} scan signal ScanB[1] can be applied to a first gate line of the display panel, and a 2A^{th} scan signal ScanA[2] and a 2B^{th} scan signal ScanB[2] can be applied to a second gate line of the display panel. Based on such a flow, a 3A^{th} scan signal ScanA[3], 3B^{th} to MA^{th} scan signal ScanB[3] to ScanA[m], and an MBth scan signal ScanB[m] can be sequentially applied to third to M^{th} gate lines of the display panel.

As seen with reference to the 1A^{th} scan signal ScanA[1] and the 1B^{th} scan signal ScanB[1], the 1A^{th} scan signal ScanA[1] can be generated to be adjacent a start time of one frame driving period, and the 1B^{th} scan signal ScanB[1] can be generated to be adjacent an end time of one frame driving period.

Hereinafter, a period-based operating state will be described based on a subpixel disposed in a first gate line.

As illustrated in FIGS. 16 and 17, during the data write period DWT, the first switching transistor SW1 can be turned on in response to the 1A^{th} scan signal ScanA[1] applied to the 1A^{th} gate line GL1a. The first switching transistor SW1 can transfer a data voltage Adata, applied through the first data line DL1, to the first electrode of the capacitor CST. The capacitor CST can have a voltage for starting an operation of the driving transistor DT.

As illustrated in FIG. 18, during the emission period EMT, the driving transistor DT can start an operation, based on a data voltage stored in the capacitor CST, and can generate a driving current. The organic light emitting diode OLED can emit light with the driving current generated from the driving transistor DT.

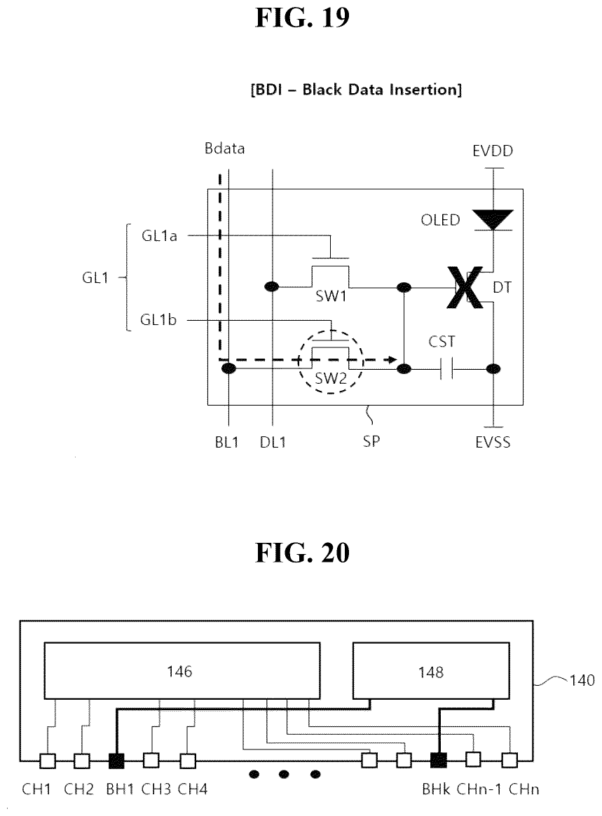

As illustrated in FIGS. 16 and 19, during the black data write period BDI, the second switching transistor SW2 can be turned on in response to the 1B^{th} scan signal ScanB[1] applied to the 1B^{th} gate line GL1b. The second switching transistor SW2 can transfer an additional voltage Bdata, applied through the first additional line BL1, to the first electrode of the capacitor CST. The capacitor CST can have a voltage for stopping an operation of the driving transistor DT.

As described above, the additional voltage Bdata can correspond to the black data voltage, and thus, an operation of the driving transistor DT can stop and the organic light emitting diode OLED can be in a non-emission state (or a black driving state).

As illustrated in FIG. 20, the data driver 140 can include a first voltage output circuit unit 146 and a second voltage output circuit unit 148, for driving of the display panel implemented based on the pixel according to the fourth embodiment.

The first voltage output circuit unit 146 can be implemented with a circuit which outputs a data voltage for expressing an image having a specific gray level on the display panel. The second voltage output circuit unit 148 can be implemented with a circuit which outputs an additional voltage for changing or varying a gray level, expressed in the display panel, to black. For example, the circuit which changes a gray level, expressed in the display panel, to black can be implemented as a circuit which outputs a direct current (DC) voltage of 0 V fixed or a voltage (a ground voltage) corresponding thereto, and the circuit which varies a gray level expressed in the display panel can be implemented as a circuit similar to the first voltage output circuit unit 146.

The data driver 140 can include data channels CH1 to CHn for outputting data voltages output from the first voltage output circuit unit 146 and additional channels BHI to BHk for outputting additional voltages output from the second voltage output circuit unit 148. The number of additional channels BHI to BHk can be less than the number of data channels CH1 to CHn. For example, the number of additional channels BHI to BHk can be about ¼ of the number of data channels CH1 to CHn.

The additional channels BHI to BHk can be arranged to be equal to the arrangement of subpixels disposed in the display panel. For example, a first additional channel BHI can be disposed between a second data channel CH2 and a third data channel CH3, based on the arrangement of the subpixels illustrated in FIG. 14.

The present disclosure can provide a display apparatus which can drive an additional line to increase a motion/moving picture response time (MPRT), depending on the case. Also, the present disclosure can shift a voltage, applied to the additional line, to various levels to increase an image expression performance of a display panel, depending on the case. Further, the present disclosure can enhance display quality, based on the voltage applied to the additional line, and can vary image expression, based on the use environment or use purpose of a display apparatus.

The effects according to various aspects of the present disclosure are not limited to the above examples, and other various effects can be included in the disclosure.

While the present disclosure has been particularly shown and described with reference to example embodiments thereof, it will be understood by those of ordinary skill in the art that various changes in form and details can be made therein without departing from the spirit and scope of the present disclosure as defined by the following claims.

What is claimed is:

1. A display apparatus comprising:
a display panel including a subpixel configured to emit light with a data voltage applied through a first data line and change an emission condition, based on an additional voltage applied through a first additional line; and
a driver configured to drive the display panel.

2. The display apparatus of claim 1, wherein the additional voltage comprises a black data voltage consisting of a direct current (DC) voltage of 0 V.

3. The display apparatus of claim 2, wherein the display panel changes the emission condition to black, based on the black data voltage.

4. The display apparatus of claim 1, wherein the display panel comprises a first data write period for applying the data voltage, an emission period for emitting light with the data voltage, and a second data write period for applying the additional voltage, and
each of the first data write period, the emission period, and the second data write period is included in one frame driving period of the display panel.

5. The display apparatus of claim 4, wherein the first data write period is provided to be adjacent to a start time of the one frame driving period, and the second data write period is provided to be adjacent to an end time of the one frame driving period.

6. The display apparatus of claim 1, wherein the subpixel comprises:
a capacitor configured to store the data voltage or the additional voltage;
a first switching transistor including a first electrode connected to the first data line, a second electrode connected to a gate electrode of the driving transistor and a first electrode of the capacitor, and a gate electrode connected to a first-first gate line;
a second switching transistor including a first electrode connected to the first additional line, a second electrode connected to the gate electrode of the driving transistor and the first electrode of the capacitor, and a gate electrode connected to a first-second gate line;
a driving transistor configured to operate based on the data voltage or the additional voltage stored in the capacitor; and
an organic light emitting diode configured to operate based on a current generated from the driving transistor.

7. The display apparatus of claim 6, wherein the organic light emitting diode comprises an anode electrode connected to a high-level voltage line and a cathode electrode connected to a first electrode of the driving transistor.

8. The display apparatus of claim 1, wherein the display panel comprises a pixel including subpixels configured to emit lights of different colors, and
the subpixels share the first additional line.

9. The display apparatus of claim 1, wherein the additional voltage comprises a black data voltage having either a direct current (DC) voltage of 0 V or a ground voltage.

10. A driving method of a display apparatus including a display panel, the driving method comprising:
a first data write operation of applying a data voltage to a subpixel of the display panel through a first data line;
an emission operation of allowing the subpixel to emit light, based on the data voltage; and
a second data write operation of applying an additional voltage to the subpixel of the display panel through a first additional line and changing an emission condition of the subpixel, based on the additional voltage.

11. The driving method of claim 10, wherein the additional voltage comprises a black data voltage consisting of a direct current (DC) voltage of 0 V.

12. The driving method of claim 11, wherein the display panel changes the emission condition to black, based on the black data voltage.

13. The driving method of claim 10, wherein the first data write operation, the emission operation and the second data write operation correspond respectively to a first data write period, an emission period and a second data write period, and
each of the first data write period, the emission period, and the second data write period is included in one frame driving period of the display panel.

14. The driving method of claim 13, wherein the first data write period is provided to be adjacent to a start time of the one frame driving period, and the second data write period is provided to be adjacent to an end time of the one frame driving period.

15. The driving method of claim 10, wherein the display panel comprises a pixel including subpixels configured to emit lights of different colors, and
the subpixels share the first additional line.

16. The driving method of claim 10, wherein the additional voltage comprises a black data voltage having either a direct current (DC) voltage of 0 V or a ground voltage.
